(19) United States
(12) Patent Application Publication
(10) Pub. No.: US 2002/0171944 A1
(43) Pub. Date: Nov. 21, 2002

(54) Condenser optical system and illumination optical apparatus provided with the optical system

(75) Inventors: Yutaka Suenaga, Kanagawa-ken (JP); Kouichi Hiraga, Kawasaki-shi (JP); Masato Kumazawa, Sagamihara-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/012,514

(22) Filed: Dec. 12, 2001

(30) Foreign Application Priority Data
Dec. 14, 2000 (JP) 2000-379838

(51) Int. Cl. G02B 15/14

(52) U.S. Cl. 359/689

(57) ABSTRACT

A condenser optical system obtains a predetermined, desired optical characteristic in a simple structure having a small number of lenses. A condenser optical system having an entrance focal plane and an exit focal plane, and that forms an image at the exit focal plane of an object located at the entrance focal plane, includes in order from an object side, a first lens group having a negative lens having a concave surface that faces the object side, a second lens group having a positive lens, and a third lens group. The first lens group has at least one aspherical lens surface.

### INCORPORATION BY REFERENCE

The disclosure of Japanese Priority Application No. 2000-379838 filed Dec. 14, 2000, is incorporated herein by reference in its entirety.

### BACKGROUND OF THE INVENTION

1. Field of the Invention

This invention relates to a condenser optical system, an illumination optical apparatus provided with the optical system, and an exposure apparatus. In particular, the invention relates to a condenser optical system which is suitable for use in an illumination optical apparatus mounted in an exposure apparatus which fabricates micro devices such as a semiconductor element, an imaging element, a liquid crystal display element, a thin film magnetic head, or the like in a lithography process.

2. Description of Related Art

In this type of exposure apparatus, a light beam emitted from a light source is incident to an optical integrator such as a fly eye lens, and a secondary light source forming a plurality of light sources is formed in the exit plane of the optical integrator. After light from the secondary light source is condensed by a condenser optical system, an illumination field is formed at a predetermined plane that is conjugate to a mask. In the vicinity of this predetermined plane, a mask blind is arranged and functions as an illumination field diaphragm.

Therefore, after a light beam from the illumination field formed in the predetermined plane is restricted via the illumination field diaphragm, a mask in which a predetermined pattern is formed is illuminated via an imaging optical system. Thus, on a mask, an image of an aperture portion of the illumination field diaphragm is formed as an illumination region. Light which passes through the mask is imaged onto a photosensitive substrate via a projection optical system. Thus, a mask pattern is projectingly exposed (transferred) onto the photosensitive substrate.

It is preferable that the above-described condenser optical system is an optical system which substantially satisfies a sine condition in order to uniformly illuminate a mask conjugate plane (i.e., a mask plane and a wafer plane). Additionally, it is preferable to use an optical system in which aberrations such as coma causing irradiation irregularity is suitably corrected.

Furthermore, recently, along with the increase of fineness of patterns to be transferred, shorter wavelengths of exposure light have been used. A 248 nm wavelength KrF excimer laser light source, a 193 nm wavelength ArF excimer laser light source, or the like is used in the exposure apparatus. In this case, it is known that fogging (i.e., the depositing of material on the optical elements) is easily generated due to generation of harmful gas by photochemical reactions that take place within the exposure apparatus, and light transmission of a lens easily deteriorates. However, from any perspective, it is advantageous to constitute a condenser optical system from a small number of lenses.

### SUMMARY OF THE INVENTION

This invention addresses the above-mentioned problems. It is one object of this invention is to provide a condenser optical system which can maintain a predetermined optical characteristic and that has a simple structure with a small number of lenses. It is another object of this invention is to provide an exposure apparatus and an illumination optical apparatus provided with a condenser optical system which maintains a predetermined optical characteristic and has a simple structure with a small number of lenses.

In order to address the above and/or other problems, according to a first aspect of this invention, a condenser optical system which is structured so that its entrance focal plane matches a first surface (an object surface) and its exit focal plane matches a second surface (an image surface) and condenses light from the first surface and guides the light to the second surface, comprises, in order from the object side, a first lens group having a negative lens with a concave surface that faces the object side, a second lens group having a positive lens, and a third lens group. The first lens group has at least one aspherical lens surface.

According to a preferred embodiment of this first aspect of the invention, the second lens group has at least one aspherical lens surface, and it is preferable that the third lens group also has at least one aspherical lens surface.

Furthermore, according to the preferred embodiment of this first aspect of the invention, when a radius of curvature of the object-side-facing concave surface of the negative lens in the first lens group is defined as R1 and a focal length of the entire optical system is defined as F, the following condition is satisfied:

0.2<F/|R1|<5.

Additionally, according to the preferred embodiment of the first aspect of the invention, the first lens group is structured by only negative lens, and is separated from the other lens groups. Furthermore, it is preferable that a composite optical system which is structured by the second lens group and the third lens group includes only two or three positive lenses.

According to a second aspect of this invention, an illumination optical apparatus comprises a light source that supplies a light beam, an optical element that forms a plurality of light sources based on the light beam received from the light source, and a condenser optical system according to the first aspect of the invention that condenses light received from the plurality of light sources and guides the light to an irradiating surface. The light from the plurality of light sources that is formed at the object surface of the condenser optical system superimposingly illuminates the image surface as the irradiating surface or a conjugate surface of the irradiating surface via the condenser optical system.

According to a third aspect of this invention, an exposure apparatus comprises the illumination optical apparatus of the second aspect of the invention, and a projection optical system that projects and exposes a pattern of a mask which is located at the irradiating surface onto a photosensitive substrate.

According to a preferred embodiment of the third aspect of the invention, if the projection optical system is a diffractive optical system, it is preferable that the illumination optical apparatus is provided with an imaging optical system arranged in an optical path between the second (image) surface and the irradiating surface, at a conjugate surface of the irradiating surface. If, however, the projection optical system is a reflective/diffractive optical system, then it is preferable that the irradiating surface matches the second (image) surface in the illumination optical apparatus.

According to a fourth aspect of this invention, a method of fabricating a micro device comprises exposing a pattern of a mask onto a photosensitive substrate by utilizing the exposure apparatus according to the third aspect of invention, and developing the photosensitive substrate which was exposed by the exposure process.

### BRIEF DESCRIPTION OF THE DRAWINGS

The invention will be described in detail with reference to the following drawings, in which like reference numerals are used to identify similar elements, and wherein:

FIG. 1 is a diagram schematically showing a structure of an exposure apparatus according to an embodiment of this invention;

FIG. 2 is a diagram showing a lens structure of a condenser optical system according to a first embodiment;

FIG. 3 shows each aberration diagram of a condenser optical system according to the first embodiment;

FIG. 4 is a diagram showing a lens structure of a condenser optical system according to a second embodiment;

FIG. 5 shows each aberration diagram of a condenser optical system according to the second embodiment;

FIG. 6 is a diagram showing a lens structure of a condenser optical system according to a third embodiment;

FIG. 7 shows each aberration diagram of a condenser optical system according to the third embodiment;

FIG. 8 is a diagram showing a lens structure of a condenser optical system according to a fourth embodiment;

FIG. 9 shows each aberration diagram of a condenser optical system according to the fourth embodiment;

FIG. 10 is a diagram showing a lens structure of a condenser optical system according to a fifth embodiment;

FIG. 11 shows each aberration diagram of a condenser optical system according to the fifth embodiment;

FIG. 12 is a diagram schematically showing a main component structure of an exposure apparatus according to a modified example of an embodiment of this invention;

FIG. 13 is a flowchart of a method of manufacturing a micro device such as a semiconductor device; and

FIG. 14 is a flowchart of a method of manufacturing a micro device such as a liquid crystal display element.

### DETAILED DESCRIPTION OF PREFERRED EMBODIMENTS

As described above, a condenser optical system of this invention is constituted so that its entrance focal plane matches a first surface (an object surface) and its exit focal plane matches a second surface (an image surface), and light from the first surface is condensed and guided to the second surface. Therefore, when a condenser optical system of this invention is used in an illumination optical apparatus of an exposure apparatus, light from a secondary light source formed at the first surface which is the exit focal plane of a fly eye lens as an optical integrator telecentrically illuminates a mask plane or a mask conjugate plane via a condenser optical system of this invention.

Specifically, a condenser optical system of this invention is provided with, in order from the object (first surface) side, a first lens group G1 having a negative lens with a concave surface that faces the object side, a second lens group G2 having a positive lens, and a third lens group G3. Furthermore, the first lens group G1 has at least one aspherical lens surface. By this structure, spherical aberration and coma can be suitably corrected by a structure having a small number of lenses. In particular, by introducing an aspherical surface to the first lens group G1, spherical aberration can be suitably corrected by a structure having a small number of lenses. Furthermore, coma can be suitably corrected by the effect of a negative lens having a concave surface that faces the object side.

The condenser optical system has an overall positive refractive power, so negative spherical aberration is generated with respect to a light beam emitted from a center of the first surface (a point on an optical axis of the first surface). Therefore, even if a condenser optical system is constituted in order to telecentrically illuminate a second surface, in other words, even if the entrance focal plane matches the first surface and the exit focal plane matches the second surface, light which illuminates a surrounding region (a region which is substantially distant from the optical axis) on the second surface is affected by the above-mentioned spherical aberration, is incident at an inclination with respect to a line that is normal to the second surface (i.e., with respect to the optical axis), and the second surface cannot be completely illuminated in a telecentric manner.

Therefore, in this invention, it is preferable that an aspherical surface is introduced to at least one of the second and third lens groups G2, G3 arranged relatively in the vicinity of the second (image) surface. By this structure, spherical aberration of a pupil can be suitably corrected with a simple structure while keeping the number of lenses small. Furthermore, the third lens group G3 is closer to the second surface than the second lens group G2. Therefore, in order to suitably correct spherical aberration of a pupil, it is more preferable that an aspherical surface is introduced to the third lens group G3 rather than the second group G2.

Furthermore, according to an aspect of this invention, it is preferable that the following condition equation (1) is satisfied.

0.2<F/|R1|<5 (1)

Here, R1 is a radius of curvature of a concave surface (radius of curvature at the vertex in the case of an aspherical surface) of a negative lens which faces the first surface side in the first lens group G1. Furthermore, F is a focal length of an entire condenser optical system.

Condition equation (1) establishes an appropriate range with respect to a ratio between a focal length F of the entire condenser optical system and a radius of curvature R1 of a concave surface of a negative lens which faces the first surface side in the first lens group G1. When the maximum value of condition equation (1) is exceeded, positive high order spherical aberration and coma are generated, and even if an aspherical surface is used, it is difficult to simultaneously correct spherical aberration and coma. Illumination irregularity is generated due to deterioration of an aberration state, which is not desirable. Meanwhile, when the value goes below the minimum value of condition equation (1), negative spherical aberration and coma are generated, and even if an aspherical surface is used, it is difficult to simultaneously correct spherical aberration and coma. Illumination irregularity is generated due to deterioration of an aspherical state, which is not preferable.

Thus, in a condenser optical system of an aspect of this invention, a predetermined optical characteristic can be maintained with a simple structure having a small number of lenses. Therefore, in an exposure apparatus and an illumination optical apparatus in which a condenser optical system of this invention is incorporated, for example, also when an excimer laser light source is used, fogging of a lens surface is not affected due to harmful gas generated by a photochemical reaction, and deterioration of light transmission of a lens is reduced. As a result, by using an exposure apparatus in which a condenser optical system of this invention is incorporated, projection exposure is performed in a preferable exposure condition, so a desired micro device can be fabricated with high accuracy.

Embodiments of this invention are now explained with reference to the attached drawings.

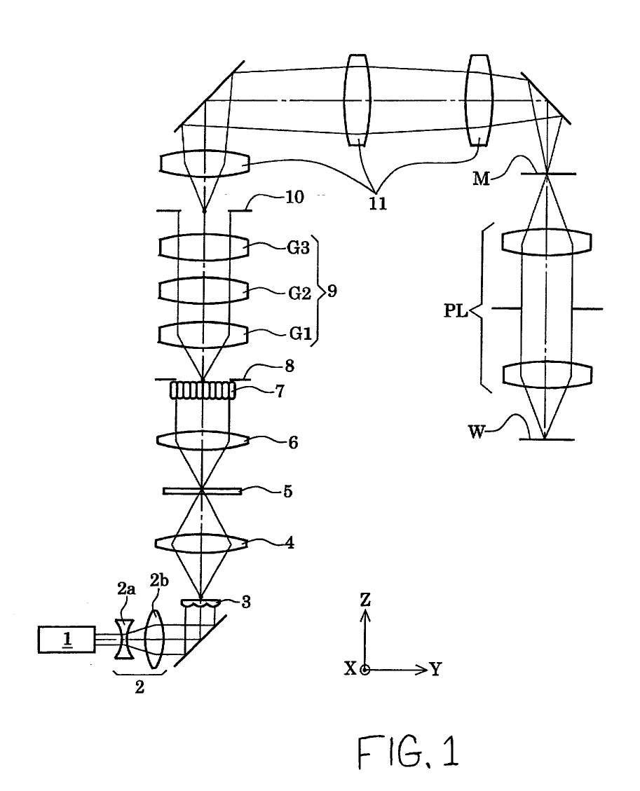

FIG. 1 is a diagram schematically showing a structure of an exposure apparatus according to an embodiment of this invention. In FIG. 1, a Z axis is set along a line normal to the plane of a wafer W which is a photosensitive substrate, a Y axis is set in a direction parallel to a paper plane of FIG. 1 within the wafer plane, and an X axis is set in a direction perpendicular to a paper plane of FIG. 1 within the wafer plane. In an exposure apparatus of FIG. 1, as a light source 1 which supplies exposure light (illumination light), an ArF excimer laser light source supplying 193 nm wavelength light is provided.

A substantially parallel light beam emitted along a Y direction from the light source 1 has a rectangular-shaped cross section which is longitudinally extended along an X direction and is incident to a beam expander 2 formed of a pair of lenses 2a and 2b. In FIG. 1, the lenses 2a and 2b have a negative refractive power and a positive refractive power, respectively. Furthermore, at least one of the pair of lenses 2a and 2b is movable along an optical axis AX. Therefore, a light beam incident to the beam expander 2 is expanded within the paper plane of FIG. 1 in response to an interval between the pair of lenses 2a and 2b and is adjusted to a light beam having a desired rectangular-shaped cross section.

After the substantially parallel light beam which passed through the beam expander 2 as a shape-adjustment optical system is deflected in a Z direction by a folding mirror, it is incident to a micro lens array 3. The micro lens array 3 is an optical element formed of a plurality of hexagon-shaped micro lenses having a positive refractive power which are densely arranged in horizontal and vertical directions (i.e., it is a two-dimensional array of micro lenses). In general, a micro lens array is constituted, for example, by forming a micro lens group by performing an etching process onto a parallel flat glass plate.

Here, each micro lens forming the micro lens array is smaller than each lens element forming the fly eye lens. Furthermore, the micro lens array is different from the fly eye lens formed of lens elements isolated from each other, in that the plurality of micro lenses are not isolated from each other, but are integrally formed. Furthermore, in FIG. 1, in order to clarify a diagram, the number of micro lenses forming the micro lens array 3 is shown as a number that is much less than the actual number.

Therefore, the light beam incident to the micro lens array 3 is two-dimensionally divided by the plurality of micro lenses, and a light source (condensing point) is formed at the exit plane of each micro lens, respectively. The light beam from the plurality of light sources formed in the exit plane of the micro lens array 3 is incident to a diffractive optical element (DOE) 5 for annular ring illumination via an afocal zoom lens 4.

The afocal zoom lens 4 is constituted so that magnification can be continuously changed in a predetermined range while an afocal system (non-focal optical system) is maintained. Furthermore, the afocal zoom lens 4 optically conjugatingly connects the exit plane of the micro lens array 3 and a diffractive plane of the diffractive optical element 5. Furthermore, the numerical aperture of the light beam which is condensed to one point on a diffractive plane of the diffractive optical element 5 changes depending on the magnification of the afocal zoom lens 4.

In general, a diffractive optical element is constituted by forming a glass substrate with a surface having different levels, with the different levels provided at a pitch substantially equal to the wavelength of exposure light (illumination light). This structure has an effect which diffracts an incident beam at a desired angle. Specifically, a diffractive optical element 5 for annular ring illumination converts the incident rectangular-shaped light beam to an annular-ring shaped (ring shape) light beam. The light beam which went through the diffractive optical element 5 is incident to a fly eye lens 7, which functions as a optical integrator, via a zoom lens 6.

In the vicinity of an exit focal plane of the zoom lens 6, an incident plane of the fly eye lens 7 is positioned. Therefore, the light beam which passed through the diffractive optical element 5 forms an annular-ring shaped illumination field centered on the optical axis AX at the exit focal plane of the zoom lens 6, and thus at an incident plane of the fly eye lens 7. The size of this annular-ring shaped illumination field changes depending on a focal length of the zoom lens 6, which is variable. Thus, the zoom lens 6 substantially connects the incident plane of the diffractive optical element 5 and the fly eye lens 7 in substantially a Fourier transform relationship.

The fly eye lens 7 is constructed by densely arranging a plurality of lens elements having a positive diffractive power horizontally and vertically (i.e., in a two-dimensional array). Furthermore, each lens element forming the fly eye lens 7 has a rectangular-shaped cross section similar to a shape of the illumination field (that is, a shape of an exposure region to be formed on a wafer) to be formed on a mask. Additionally, a plane of an incident side of each lens element forming the fly eye lens 7 is formed in a spherical state having a convex surface that faces an incident (entrance) side, and a surface of the exit side is formed in a spherical state having a convex surface that faces the exit side.

Therefore, the light beam which was incident to the fly eye lens 7 is two-dimensionally divided by the plurality of lens elements, and a plurality of light sources are respectively formed at the exit focal plane of each lens element to which the light beam was incident. Thus, an annular-ring shaped plane light source (hereafter referred to as “secondary light source”) having substantially the same light intensity distribution as the illumination field formed by incident light to the fly eye lens 7 is formed. The light from the annular-ring shaped secondary light source formed at the exit focal plane of the fly eye lens 7 is incident to an aperture stop 8 arranged in the vicinity of the exit focal plane of the fly eye lens 7.

After the light from the secondary light source via the aperture stop 8 having an annular-ring shaped optical portion (light transmissive portion) is condensed by the condenser optical system 9, the light superimposingly illuminates the exit focal plane of the condenser optical system 9. The aperture stop 8 is arranged at the entrance focal plane of the condenser optical system 9. Thus, at the exit focal plane of the condenser optical system 9, a rectangular-shaped illumination field similar to the shape of each lens element forming the fly eye lens 7 is formed. Furthermore, the details of condenser optical system 9 will be discussed later with reference to five embodiments.

A mask blind 10 is arranged as an illumination field diaphragm in a specified plane on which the above-mentioned rectangular-shaped illumination field is formed. After the light beam which passed through the rectangular-shaped aperture portion (light transmissive portion) of the mask blind 10 is condensed by an imaging optical system 11, the light superimposing illuminates a mask M on which a specified pattern is formed. Thus, the imaging optical system 11 forms an image of the rectangular-shaped aperture portion of the mask blind 10 on the mask M.

The light beam which passes through the pattern of the mask M forms an image of the mask pattern on a wafer W, which is a photosensitive substrate, via a diffractive type projection optical system PL formed of a plurality of lens components. Thus, in a plane (XY plane) perpendicular to the optical axis AX of the projection optical system PL, while the wafer W is two-dimensionally driven, batch exposure or scanning exposure is performed. By this operation, a pattern of the mask M is consecutively exposed in each exposure region of the wafer W.

Furthermore, in batch exposure, according to a so-called step and repeat method, a mask pattern is exposed in a batch manner (i.e., all at once) with respect to each exposure region of a wafer. In this case, a shape of an illumination region on the mask M is a rectangular shape, usually a square shape, and a cross-sectional shape of each lens elements of the fly eye lens 7 is also a rectangular shape, usually a square shape. Meanwhile, in scanning exposure, according to a so-called step and scan method, as a mask and a wafer are relatively moved with respect to a projection optical system, the mask pattern is scanningly exposed with respect to each exposure region of the wafer. In this case, the shape of the illumination region on the mask M is a rectangular shape whose ratio is, for example, 1:3, short side/long side, and a cross-sectional shape of each lens element of the fly eye lens 7 also is a rectangular shape which is similar to this shape.

Furthermore, in this embodiment, by changing the magnification of the afocal zoom lens 4, both an external diameter (size) and an annular-ring ratio (shape) of the annular-ring shaped secondary light source can also be changed. Furthermore, by changing a focal length of the zoom lens 6, without changing an annular-ring ratio of the annular-ring shaped secondary light source, the external diameter can be changed. As a result, by appropriately changing the magnification of the afocal zoom lens 4 and the focal length of the zoom lens 6, without changing the external diameter of the annular-ring shaped secondary light source, only the annular-ring ratio can be changed.

Furthermore, in this embodiment, by replacing the diffractive optical element 5 for annular-ring illumination with, for example, a diffractive optical element for quadrupolar illumination and a diffractive optical element for eight-pole illumination, special illumination such as quadrupole illumination and eight-pole illumination can be performed. In this case, along with replacement of the diffractive optical element 5, the annular-ring aperture stop 8 is replaced with, for example, a quadrupole aperture diaphragm and an eight-pole aperture diaphragm. Furthermore, by removing the micro lens array 3 from the illumination optical path and simultaneously replacing the diffractive optical element 5 for annular-ring illumination with a diffractive optical element for normal round-shaped illumination, normal round-shaped illumination can also be performed. In this case, along with replacement of the diffractive optical element 5, the annular-ring aperture stop 8 is replaced with a round-shaped aperture diaphragm.

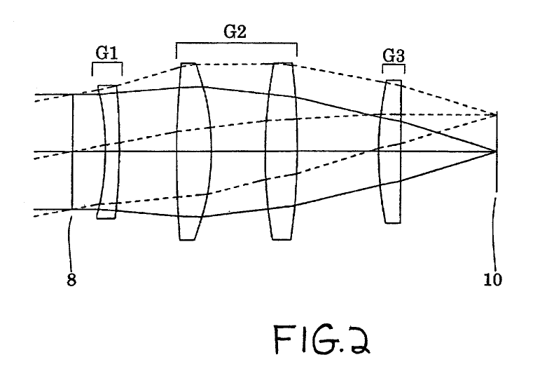

FIG. 2 shows a lens structure of a condenser optical system according to a first embodiment. As shown in FIG. 2, in a condenser optical system of the first embodiment, a first lens group G1 is constituted by a negative meniscus lens having an aspherical shaped concave surface that faces the first (or object) surface side (aperture stop 8 side). Furthermore, a second lens group G2 is constructed by two bi-convex lenses. In addition, a third lens group G3 is constructed by a flat convex lens having an aspherical shaped convex surface that faces the first (object) surface side. Furthermore, all four lenses forming the condenser optical system of the first embodiment are formed of quartz.

Furthermore, in each embodiment, when the height in a direction perpendicular to an optical axis is y, a distance (sag amount) along the optical axis from a contact plane at the vertex of the aspherical surface to a position on the aspherical surface in height y is x, a radius of curvature at the vertex is r, a conical coefficient is κ, and an n-order aspherical coefficient is C_{n,} an aspherical surface can be shown in the following equation (a).

x=(y²/r)/[1+{1−κ·y²/r²}^{½}]+C₄·y⁴+C₆·y⁶+C₈·y⁸+C₁₀·y¹⁰ (a)

In each embodiment, * is used on the right side of a surface number for a lens surface formed in an aspherical shape.

In the following Table (1), values of a condenser optical system of the first embodiment are listed. In Table (1), F shows a focal length of the condenser optical system. Furthermore, in each optical member of Table (1), a surface number of the first column shows an order of a surface along a direction in which a light beam proceeds, r of the second column shows a radius of curvature (radius of curvature at the vertex in the case of an aspherical surface: mm) of each surface, d of the third column shows an on-axis interval of each surface, that is, the interval (mm) between surfaces, and n of the fourth column shows an index of refraction with respect to the exposure light (having a 193 nm wavelength).

TABLE 1
(Main values)
F = 210.00 mm
(Optical member values)

| Surface number | r | D | n |
|---|---|---|---|
| | (Aperture stop 8) | 35.00000 | |
| 1* | −290.45056 | 15.00000 | 1.560326 |
| 2 | −629.77405 | 61.46628 | |
| 3 | 1000.00000 | 38.00000 | 1.560326 |
| 4 | −245.16870 | 57.46986 | |
| 5 | 505.54910 | 34.00000 | 1.560326 |
| 6 | −680.00000 | 86.91785 | |
| 7* | 366.82922 | 24.00000 | 1.560326 |
| 8 | ∞ | 103.15489 | |

(Mask blind 10)
(Aspherical surface data)

| | |
|---|---|
| First surface | |
| κ = 1.00000 | |
| C₄ = −0.5778271 × 10⁻⁷ | C₆ = 0.1152999 × 10⁻¹⁰ |
| C₈ = −0.3376791 × 10⁻¹⁴ | C₁₀ = 0.2925465 × 10⁻¹⁸ |
| Seventh surface | |
| κ = 1.00000 | |
| C₄ = −0.2116710 × 10⁻⁸ | C₆ = 0.3618270 × 10⁻¹¹ |
| C₈ = −0.6772010 × 10⁻¹⁵ | C₁₀ = 0.3479260 × 10⁻¹⁹ |
| (Condition equation corresponding value) | |
| R1 = −290.45 mm | |
| (1) F/\|R1\| = 1.383 | |

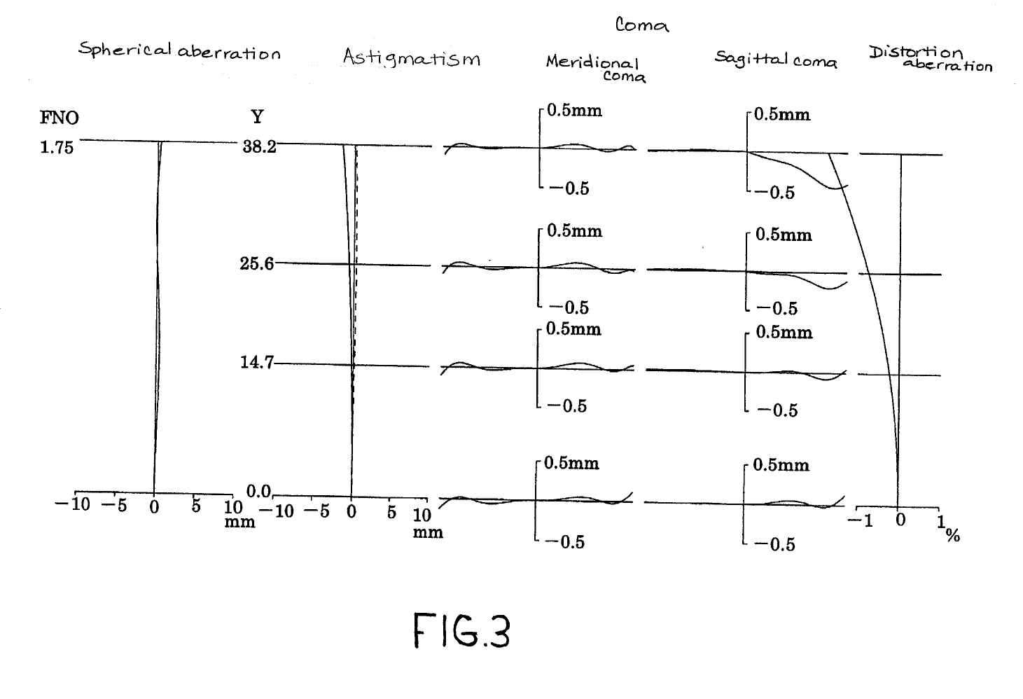

FIG. 3 shows each aberration diagram of a condenser optical system according to the first embodiment. In each aberration diagram, FNO shows an F number, and Y shows image height. Furthermore, in the aberration diagram showing astigmatism, a solid line shows a sagittal image plane, and a broken line shows a meridional image plane. As demonstrated from each aberration diagram, in the first embodiment, each aberration is suitably corrected, and an excellent imaging performance capability is maintained.

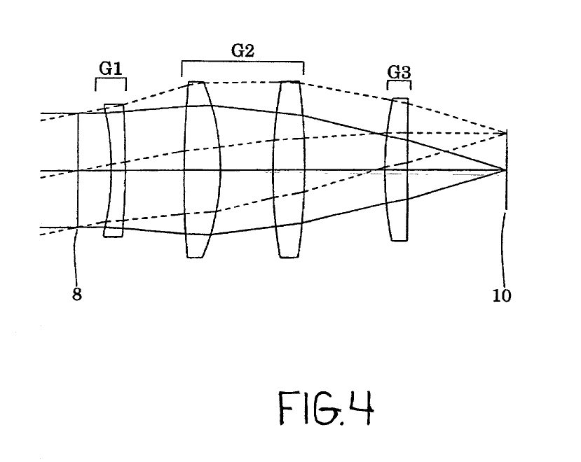

FIG. 4 shows a lens structure of a condenser optical system according to a second embodiment. As shown in FIG. 4, in a condenser optical system of the second embodiment, a first lens group G1 is constituted by a negative meniscus lens having an aspherical-shaped concave surface that faces the first (object) surface side (aperture stop 8 side). Furthermore, a second lens group G2 is constituted by, in order from the first surface side, a bi-convex lens and a bi-convex lens having an aspherical-shaped convex surface that faces the first surface side. In addition, a third lens group G3 is constituted by a flat convex lens having a flat surface that faces a second (image) surface side (mask blind 10 side). Furthermore, in the second embodiment as well, all four lenses are formed of quartz.

In the following Table (2), values of the condenser optical system according to the second embodiment are listed. In Table (2), F shows a focal length of a condenser optical system. Furthermore, in the optical member values of Table (2), a surface number of the first column shows the order of surfaces along a direction in which a light beam proceeds, r of the second column shows the radius of curvature of each surface (radius of curvature at the vertex in the case of an aspherical surface: mm), d of the third column shows an on-axis interval of each surface, that is, interval (mm) between surfaces, and n of the fourth column shows an index of refraction with respect to the exposure light (having a 193 nm wavelength).

TABLE 2
(Main values)
F = 210.00 mm
(Optical member values)

| Surface number | r | D | n |
|---|---|---|---|
| | (Aperture stop 8) | 35.00000 | |
| 1* | −338.02484 | 15.00000 | 1.560326 |
| 2 | −908.99786 | 61.32851 | |
| 3 | 1000.00000 | 38.00000 | 1.560326 |
| 4 | −244.62560 | 56.76844 | |
| 5* | 521.55481 | 34.00000 | 1.560326 |
| 6 | −680.00000 | 86.38004 | |
| 7 | 354.17026 | 24.00000 | 1.560326 |
| 8 | ∞ | 104.52473 | |

(Mask blind 10)
(Aspherical surface data)

| | |
|---|---|
| First surface | |
| κ = 1.00000 | |
| C₄ = −0.6139072 × 10⁻⁷ | C₆ = 0.1022614 × 10⁻¹⁰ |
| C₈ = −0.2636839 × 10⁻¹⁴ | C₁₀ = 0.2056093 × 10⁻¹⁸ |
| Fifth surface | |
| κ = 1.00000 | |
| C₄ = 0.2987970 × 10⁻⁸ | C₆ = 0.5271300 × 10⁻¹² |
| C₈ = −0.1221230 × 10⁻¹⁵ | C₁₀ = 0.6554500 × 10⁻²⁰ |
| (Condition equation corresponding value) | |
| R1 = −338.02 mm | |
| (1) F/\|R1\| = 1.6096 | |

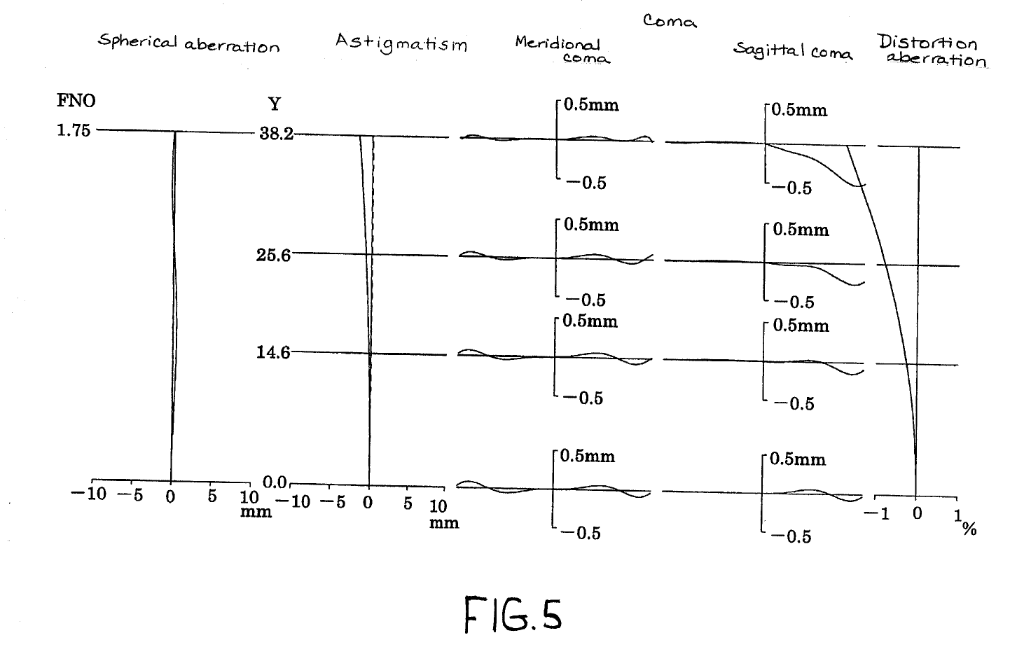

FIG. 5 shows each aberration diagram of a condenser optical system according to the second embodiment. In each aberration diagram, FNO shows an F number, and Y shows image height. Furthermore, in the aberration diagram showing astigmatism, a solid line shows a sagittal image plane, and a broken line shows a meridional image plane. As demonstrated from each aberration diagram, in the second embodiment as well, each aberration can be suitably corrected, and an excellent imaging performance capability is maintained.

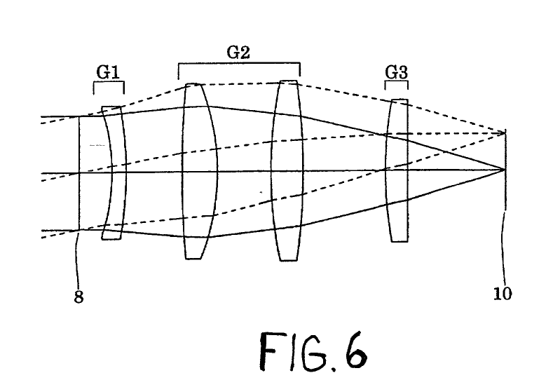

FIG. 6 shows a lens structure of a condenser optical system according to a third embodiment. As shown in FIG. 6, in a condenser optical system of the third embodiment, a first lens group G1 is structured by a negative meniscus lens having a concave surface that faces a first surface side (aperture stop 8 side) and having an aspherical shaped convex surface that faces a second (image) surface side (mask blind 10 side). Additionally, a second lens group G2 is structured by two bi-convex lenses. In addition, a third lens group G3 is structured by a flat convex lens having an aspherical shaped convex surface that faces the first surface side. Furthermore, in the third embodiment as well, all four lenses are formed of quartz.

In the following Table (3), values of a condenser optical system according to the third embodiment are listed. In Table (3), F shows a focal length of a condenser optical system. Furthermore, in the optical member values of Table (3), a surface number of the first column shows the order of surfaces along a direction in which a light beam proceeds, r of the second column shows the radius of curvature of each surface (radius of curvature at the vertex in the case of an aspherical surface: mm), d of the third column shows an on-axis interval of each surface, that is, the interval (mm) between surfaces, and n of the fourth column shows an index of refraction with respect to the exposure light beam (having a 193 nm wavelength).

TABLE 3
(Main values)
F = 210.00 mm
(Optical member values)

| Surface number | r | d | n |
|---|---|---|---|
| | (Aperture stop 8) | 35.00000 | |
| 1 | −206.11157 | 15.00000 | 1.560326 |
| 2* | −359.18127 | 59.24475 | |
| 3 | 1000.00000 | 38.00000 | 1.560326 |
| 4 | −246.79173 | 57.30085 | |
| 5 | 460.08212 | 34.00000 | 1.560326 |
| 6 | −680.00000 | 87.61604 | |
| 7* | 403.13458 | 24.00000 | 1.560326 |
| 8 | ∞ | 104.85065 | |

(Mask blind 10)
(Aspherical surface data)

| | |
|---|---|
| Second surface | |
| κ = 1.00000 | |
| C₄ = 0.4813953 × 10⁻⁷ | C₆ = −0.8858789× 10⁻¹¹ |
| C₈ = 0.2269315 × 10⁻¹⁴ | C₁₀ = −0.1760198 × 10⁻¹⁹ |
| Seventh surface | |
| κ = 1.00000 | |
| C₄ = −0.3925310× 10⁻⁸ | C₆ = 0.4128611 × 10⁻¹¹ |
| C₈ = −0.9684070 × 10⁻¹⁵ | C₁₀ = 0.7163660 × 10⁻¹⁹ |
| (Condition equation corresponding value) | |
| R1 = −206.11 mm | |
| (1) F/\|R1\| = 0.9815 | |

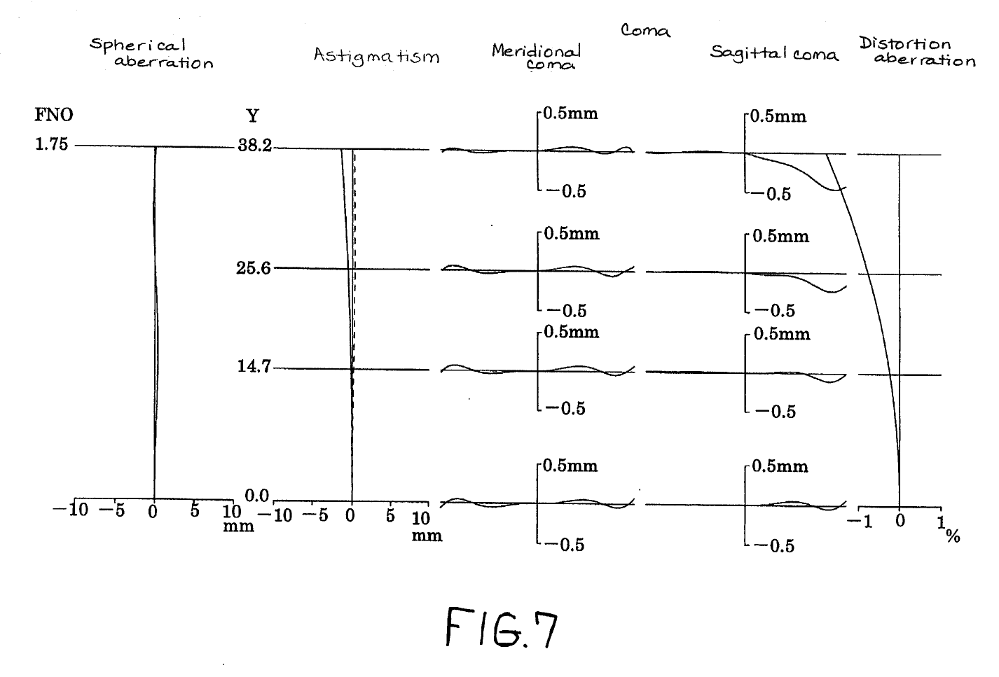

FIG. 7 shows each aberration diagram of a condenser optical system according to the third embodiment. In each aberration diagram, FNO shows an F number, and Y shows image height. Furthermore, in the aberration diagram showing astigmatism, a solid line shows a sagittal image plane, and a broken line shows a meridional image plane. As demonstrated from each aberration diagram, in the third embodiment as well, each aberration can be suitably corrected, and an excellent imaging performance capability is maintained.

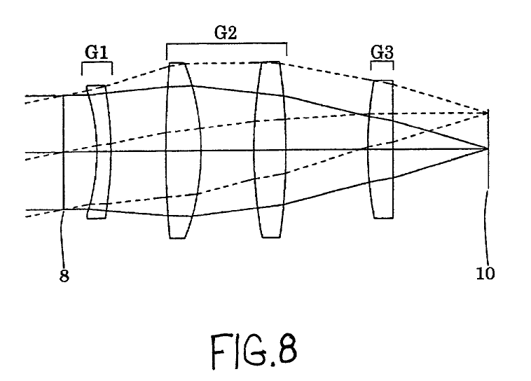

FIG. 8 shows a lens structure of a condenser optical system according to a fourth embodiment. As shown in FIG. 8, in a condenser optical system of the fourth embodiment, a first lens group G1 is structured by a negative meniscus lens having a concave surface that faces a first (object) surface side (aperture stop 8 side) and having an aspherical shaped convex surface that faces a second (image) surface side (mask blind 10 side). In addition, a second lens group G2 is structured by two bi-convex lenses. Furthermore, a third lens group G3 is constituted by a flat convex lens having an aspherical shaped convex surface that faces the first surface side. Furthermore, in the fourth embodiment as well, all four lenses are formed of quartz.

In the following Table (4), values of a condenser optical system according to embodiment are listed. In Table (4), F shows a focal length of a condenser optical system. In addition, in the optical member values of Table (4), a surface member of the first column shows an order of a surface along a direction in which a light beam proceeds, r of the second column shows a radius of curvature of each surface (radius of curvature at the vertex in the case of an aspherical surface: mm), d of the third column shows an on-axis interval of each surface, that is, the interval (mm) between surfaces, and n of the fourth column shows an index of refraction with respect to the exposure light (having a 193 nm wavelength).

TABLE 4
(Main values)
F = 210.00 mm
(Optical member values)

| Surface number | r | d | n |
|---|---|---|---|
| | (Aperture stop 8) | 35.00000 | |
| 1 | −205.26913 | 15.00000 | 1.560326 |
| 2* | −349.92252 | 58.36976 | |
| 3 | 1000.00000 | 38.00000 | 1.560326 |
| 4 | −244.16177 | 57.76111 | |
| 5 | 488.00562 | 34.00000 | 1.560326 |
| 6 | −680.00000 | 88.17891 | |
| 7* | 382.84335 | 27.00000 | 1.560326 |
| 8 | ∞ | 101.70313 | |

(Mask blind 10)
(Aspherical data)

| | |
|---|---|
| Second surface | |
| κ = 1.00000 | |
| C₄ = 0.4847491 × 10⁻⁷ | C₆ = −0.8890691 × 10⁻¹¹ |
| C₈ = 0.2285513 × 10⁻¹⁴ | C₁₀ = −0.1775566 × 10⁻¹⁸ |
| Seventh surface | |
| κ = 1.00000 | |
| C₄ = −0.3077470 × 10⁻⁸ | C₆ = 0.4338797 × 10⁻¹¹ |
| C₈ = −0.1007849 × 10⁻¹⁴ | C₁₀ = 0.7463910 × 10⁻¹⁹ |
| (Condition equation corresponding value) | |
| R1 = −205.27 mm | |
| (1) F/\|R\| = 0.9775 | |

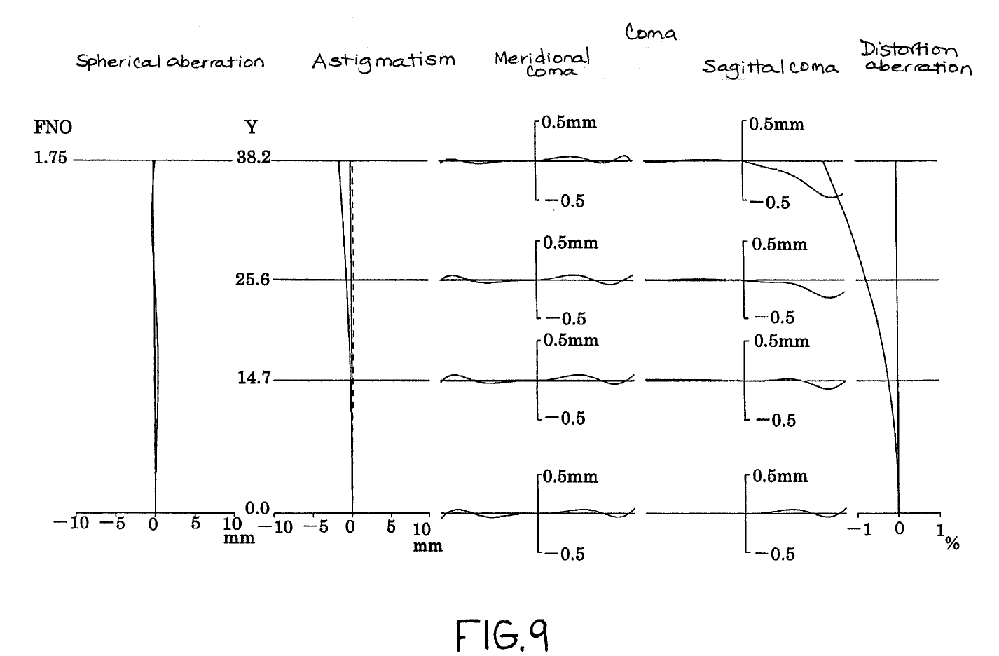

FIG. 9 shows each aberration diagram of a condenser optical system according to the fourth embodiment. In each aberration diagram, FNO shows an F number, and Y shows image height. Furthermore, in the aberration diagram showing astigmatism, a solid line shows a sagittal image plane, and a broken line shows a meridional image plane. As clarified from each aberration diagram, in the fourth embodiment as well, each aberration can be suitably corrected, and an excellent imaging performance capability is maintained.

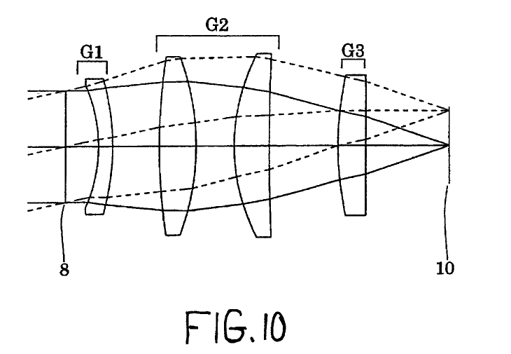

FIG. 10 shows a lens structure of a condenser optical system according to a fifth embodiment. As shown in FIG. 10, in the condenser optical system of the fifth embodiment, a first lens group G1 is constituted by a negative meniscus lens having a concave surface that faces a first surface side (aperture stop 8 side) and having an aspherical shaped convex surface that faces a second (image) surface side (mask blind 10 side). Furthermore, a second lens group G2 is constituted by, in order from the first surface side, a bi-convex lens and a positive meniscus lens having a convex surface that faces the first surface side. In addition, a third lens group G3 is constituted by a flat convex lens which has an aspherical surface shaped convex surface that faces the first surface side. Additionally, in the fifth embodiment as well, all four lenses are formed of quartz.

In the following Table (5), values of a condenser optical system according to the fifth embodiment are listed. In Table (5), F shows a focal length of a condenser optical system. Furthermore, in the optical member values of Table (5), a surface number of the first column shows an order of a surface along a direction in which a light beam proceeds, r of the second column shows a radius of curvature of each surface (radius of curvature at the vertex in the case of an aspherical surface: mm), d of the third column shows an on-axis interval of each surface, that is, the interval (mm) between surfaces, and n of the fourth column shows an index of refraction with respect to the exposure light (having a 193 nm wavelength).

TABLE 5
(Main values)
F = 182.80 mm
(Optical member values)

| Surface number | r | d | n |
|---|---|---|---|
| | (Aperture stop 8) | 36.00000 | |
| 1 | −156.82307 | 15.00000 | 1.560326 |
| 2* | −253.51184 | 49.78377 | |
| 3 | 650.00000 | 39.00000 | 1.560326 |
| 4 | −271.34277 | 40.84352 | |
| 5 | 210.00000 | 37.00000 | 1.560326 |
| 6 | 1915.74000 | 73.49748 | |
| 7* | 315.28098 | 29.96341 | 1.560326 |
| 8 | ∞ | 88.91925 | |

(Mask blind 10)
(Aspherical data)

| | |
|---|---|
| Second surface | |
| κ = 1.00000 | |
| C₄ = 0.3300231 × 10⁻⁷ | C₆ = −0.8553463 × 10⁻¹¹ |
| C₈ = 0.1904891 × 10⁻¹⁴ | C₁₀ = −0.1310667 × 10⁻¹⁸ |
| Seventh surface | |
| κ = = 1.00000 | |
| C₄ = −0.4028710 × 10⁻⁷ | C₆ = 0.7077420 × 10⁻¹¹ |
| C₈ = −0.1699194 × 10⁻¹⁴ | C₁₀ = 0.1201208 × 10⁻¹⁸ |
| (Condition equation corresponding value) | |
| R1 = −156.82 mm | |
| (1) F/\|R1\| = 0.8579 | |

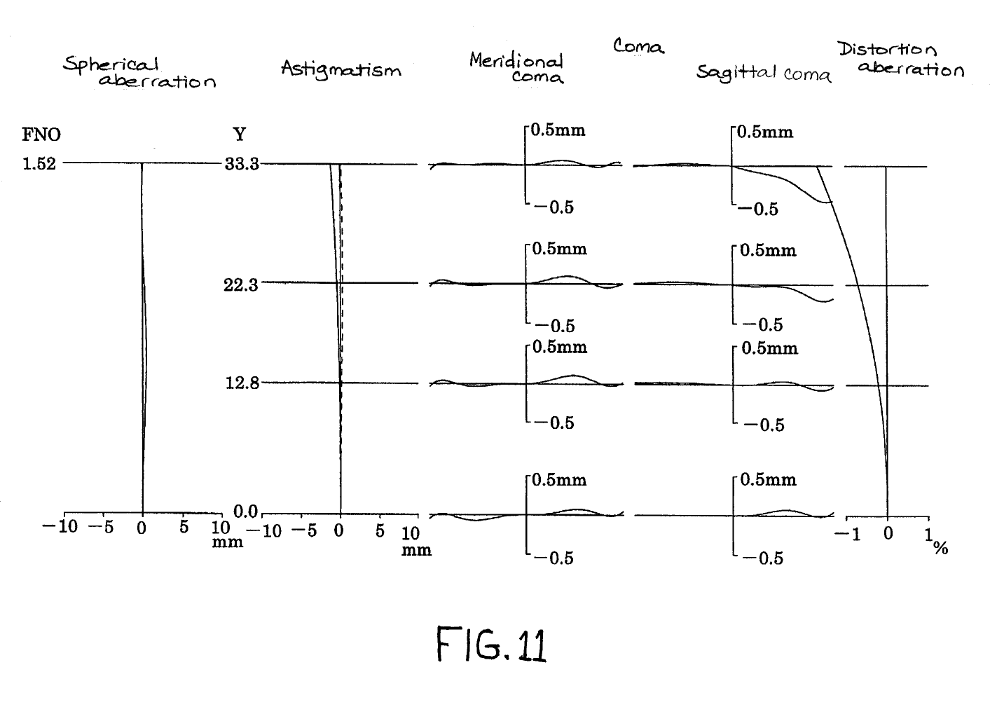

FIG. 11 shows each aberration diagram of a condenser optical system according to the fifth embodiment. In each aberration diagram, FNO shows an F number, and Y shows image height. Furthermore, in the aberration diagram showing astigmatism, a solid line shows a sagittal image plane, and a broken line shows a meridional image plane. As demonstrated from each aberration diagram, in the fifth embodiment as well, each aberration can be suitably corrected, and an excellent imaging performance capability is maintained.

Thus, in a condenser optical system according to each embodiment of this invention, each aberration can be suitably corrected by an extremely small number of lenses, i.e., a total of four lenses, and a predetermined optical characteristic can be maintained. Therefore, in an illumination optical apparatus and an exposure apparatus of this embodiment, in spite of using an ArF excimer laser light source, adverse effects due to fogging of the lens surface from the harmful gas generated by a photochemical reaction are not easily generated, and deterioration of light transmission of the lens does not easily occur.

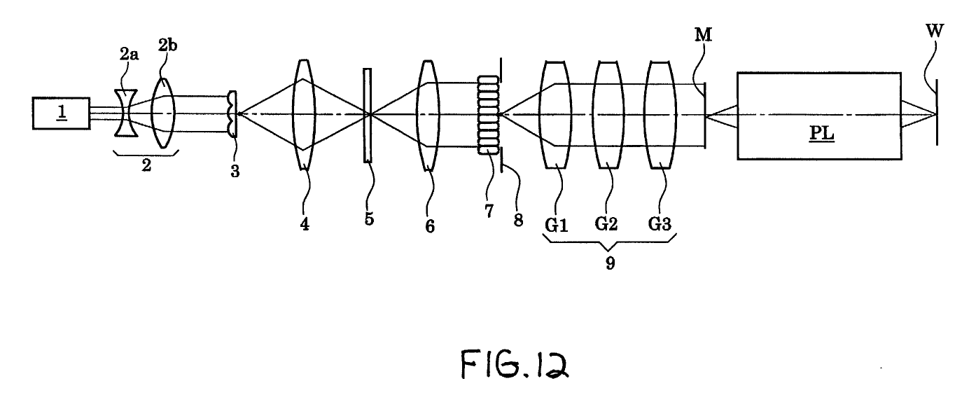

FIG. 12 is a diagram schematically showing a structure of an exposure apparatus according to a modified example of an embodiment of this invention. The modified example of FIG. 12 has a structure similar to an embodiment of FIG. 1. However, in the embodiment of FIG. 1, as described before, the projection optical system is a diffractive type optical system. Meanwhile, in the modified example of FIG. 12, the projection optical system is a reflective diffractive type optical system constituted by a dioptric member (concave surface reflective mirror or the like) having a reflective curved surface and a diffractive optical member (lens component or the like) having a diffractive curved surface.

Furthermore, in the embodiment of FIG. 1, a mask blind 10 is arranged on the exit focal plane of the condenser optical system 9, and an imaging optical system 11 is arranged in an optical path between the mask blind 10 and the mask M. Meanwhile, in the modified example of FIG. 12, a mask M is arranged on the exit focal plane of the condenser optical system 9, and the mask blind 10 and the imaging optical system 11 are omitted. Furthermore, in FIG. 12, the elements having the same functions as the elements of the embodiment of FIG. 1 have the same reference symbols as in FIG. 1.

In general, in a diffractive type projection optical system, spherical aberration of a pupil remains to some degree. In this case, a pattern image of a mask is not telecentrically projected onto a photosensitive substrate, so distortion is generated by a minute defocus (position shift between a photosensitive substrate and an image plane of a projection optical system). Therefore, in an illumination system of an exposure apparatus, an imaging optical system which optically conjugatingly connects an illumination field diaphragm (mask blind) with a mask needs to compensate (correct) spherical aberration of a pupil of a projection optical system.

Therefore, in the embodiment of FIG. 1, an aberration structure is used in which spherical aberration of a pupil of the imaging optical system 11 compensates spherical aberration of the pupil of a diffractive type projection optical system PL. Meanwhile, a reflective diffractive type projection optical system can be structured so that spherical aberration of a pupil is substantially nonexistent. Therefore, in the modified example of FIG. 12, by omitting arrangement of the imaging optical system 11, a structure is possible which directly illuminates the mask M via the condenser optical system 9. In this case, a field diaphragm which establishes an effective illumination region (that is, an effective exposure region on the wafer W) on the mask M can be optically conjugatingly arranged in an optical path of a reflective diffractive type projection optical system. Furthermore, in FIG. 12, a transmissive type mask M is used, but this can also be applied to a reflective type mask.

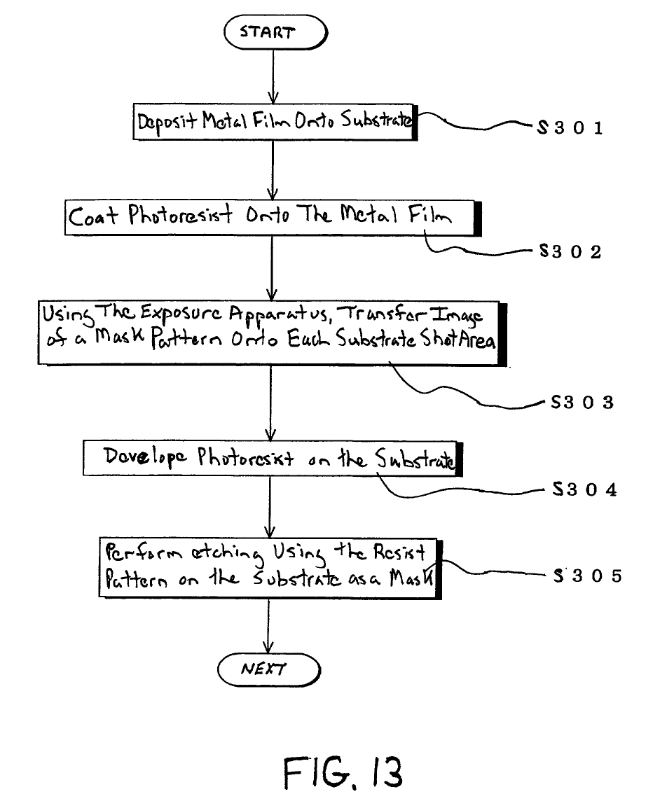

In the exposure apparatus according to this embodiment (including the modified example), by illuminating a mask (reticle) by an illumination optical apparatus (illumination process) and exposing a pattern formed in the mask onto a photosensitive substrate by using a projection optical system (exposure process), a micro device (e.g., a semiconductor element, imaging element, a liquid crystal display element, a thin film magnetic head, or the like) can be manufactured. The following explains one example of a method of obtaining a semiconductor device (as one type of micro device) by forming a predetermined circuit pattern in a wafer or the like as a photosensitive substrate by using an exposure apparatus of this embodiment with reference to a flowchart of FIG. 13.

First, in step S301 of FIG. 13, a metal film is deposited on one lot of wafers. In the following step S302, a photoresist is coated on the metal film on the one lot of wafers. After that, in step S303, by using the exposure apparatus of any of the disclosed embodiments, an image of a pattern on a mask is sequentially exposed and transferred onto each shot region on the one lot of wafers via the projection optical system. After that, in step S304, after a photoresist on the one lot of wafers is developed, in step S305, by etching the resist pattern on the one lot as a mask, a circuit pattern corresponding to a pattern on the mask is formed in each shot region on each wafer. After that, a device such as a semiconductor element or the like is manufactured by forming a circuit pattern of additional upper layers. According to the above-mentioned method of fabricating a semiconductor device, a semiconductor device having an extremely fine circuit pattern can be obtained with a good throughput.

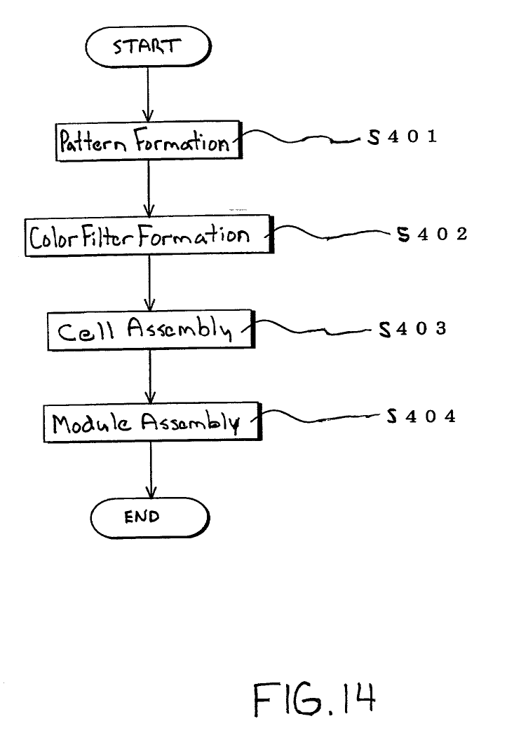

Furthermore, in the exposure apparatus of this embodiment, by forming a predetermined pattern (circuit pattern, electrode pattern, or the like) on a plate (e.g., a glass or quartz substrate), a liquid crystal display element (as one type of micro device) can also be obtained. The following shows one example of this method with reference to the flowchart of FIG. 14. In FIG. 14, in a pattern formation process S401, by using the exposure apparatus of any of the embodiments, a so-called photolithography process in performed in which a pattern of a mask is transferred and exposed onto a photosensitive substrate (a glass substrate or the like on which a resist is coated). According to this photolithography process, a predetermined pattern including a plurality of electrodes or the like is formed on a photosensitive substrate. After that, with respect to the exposed substrate, by going through each process such as a developing process, an etching process, a reticle removal process, and the like, a predetermined pattern is formed on the substrate, and the substrate goes to the following color filter formation process S402.

Next, in the color filter formation process S402, a color filter is formed in which a plurality of three-dot groups corresponding to R (Red), G (Green), and B (Blue) are aligned in a matrix, or a plurality of filter groups of three stripes R, G and B are aligned in a horizontal scanning line direction. Thus, after the color filter formation process S402, a cell assembly process S403 is performed. In the cell assembly process S403, a liquid crystal panel (liquid crystal cell) is assembled by using a substrate having a predetermined pattern which was obtained in the pattern formation process S401 and a color filter or the like which was obtained in the color filter formation process S402. In the cell assembly process S403, for example, a liquid crystal panel (liquid crystal cell) is fabricated by filling liquid crystal material in between the color filter obtained in the color filter formation process S402 and the substrate having a predetermined pattern obtained in the pattern formation process S401.

After that, in the module assembly process S404, a liquid crystal display element is completed by attaching parts such as an electrical circuit which performs a display operation of an assembled liquid crystal panel (liquid crystal cell), a back light, and the like. According to a method of fabricating the above-mentioned liquid crystal display element, a liquid crystal display element having an extremely fine circuit pattern can be obtained with a good throughput.

Furthermore, in the above-mentioned embodiment, an ArF excimer laser light source is used; however, the invention is not limited to this. For example, other appropriate light sources such as a KrF excimer laser light source which supplies a 248 nm wavelength and an F₂ excimer laser light source which supplies a 156 nm wavelength can also be used. Furthermore, in the above-mentioned embodiment, this invention is applied to a condenser optical system in an illumination optical apparatus in an exposure apparatus, but the invention is not limited to this.

As explained above, in the condenser optical system of embodiments of this invention, a predetermined optical characteristic can be obtained in a simple structure with a small number of lenses. Therefore, in an exposure apparatus and an illumination optical apparatus in which a condenser optical system of this invention is incorporated, for example, when an excimer laser light source is used, the apparatus is not easily affected by fogging of a lens surface due to harmful gas generated by a photochemical reaction, and the light transmission characteristics of the lens is not readily deteriorated.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A condenser optical system having an entrance focal plane and an exit focal plane, and that forms an image at the exit focal plane of an object located at the entrance focal plane, the condenser optical system comprising:
in order from an object side, a first lens group having a negative lens having a concave surface that faces the object side, a second lens group having a positive lens, and a third lens group, wherein the first lens group has at least one aspherical lens surface.

2. The condenser optical system according to claim 1, wherein the second lens group has at least one aspherical lens surface.

3. The condenser optical system according to claim 2, wherein the third lens group has at least one aspherical lens surface.

4. The condenser optical system according to claim 1, wherein the third lens group has at least one aspherical lens surface.

5. The condenser optical system according to claim 1, wherein, when a radius of curvature of the concave surface of the negative lens that faces the object side in the first lens group is defined as R1, and a focal length of the entire condenser optical system is defined as F, the following condition is satisfied:
0.2<F/|R1|<5.

6. The condenser optical system according to claim 1, wherein the first lens group consists of only the negative lens.

7. The condenser optical system according to claim 1, wherein a composite optical system which is formed by the second lens group and the third lens group consists of no more than three positive lenses.

8. An illumination optical apparatus, comprising:
a light source that supplies a light beam;
an optical member that forms a plurality of light sources from the light beam supplied from the light source; and
the condenser optical system according to claim 1, which condenses the light from the plurality of light sources, and guides the light to an irradiating surface;
wherein the light from the plurality of light sources is formed at the entrance focal plane and is superimposingly illuminated to the irradiating surface or to a surface that is conjugate to the irradiating surface.

9. An exposure apparatus, comprising:
the illumination optical apparatus according to claim 8, and
a projection optical system that projects a pattern of a mask located at the irradiating surface onto a photosensitive substrate in order to expose the photosensitive substrate.

10. The exposure apparatus according to claim 9, wherein:
the projection optical system is a diffractive optical system; and
the illumination optical apparatus includes an imaging optical system arranged in an optical path between the exit focal plane and the irradiating surface and the irradiating surface.

11. The exposure apparatus according to claim 9, wherein the projection optical system is a reflective/diffractive optical system, and the irradiating surface is located at the exit focal plane in the illumination optical apparatus.

12. A method of fabricating a micro device, comprising:
exposing a pattern of the mask onto the photosensitive substrate utilizing the exposure apparatus according to claim 9; and
developing the exposed photosensitive substrate.
